(19) United States
(12) Patent Application Publication
(10) Pub. No.: US 2014/0173426 A1
(43) Pub. Date: Jun. 19, 2014

(54) SEAMLESSLY INCORPORATING ONLINE CONTENT INTO DOCUMENTS

(71) Applicant: MICROSOFT CORPORATION, REDMOND, WA (US)

(72) Inventors: XUEDONG HUANG, BELLEVUE, WA (US); STEVEN MACBETH, REDMOND, WA (US); LAWRENCE BRIAN RIPSHER, SEATTLE, WA (US); BRIAN ALBRECHT, KIRKLAND, WA (US); LISA WOODS, REDMOND, WA (US)

(73) Assignee: MICROSOFT CORPORATION, REDMOND, WA (US)

(21) Appl. No.: 13/720,128

(22) Filed: Dec. 19, 2012

(51) Int. Cl. G06F 17/24

(52) U.S. Cl. CPC G06F 17/24
USPC 715/256

(57) ABSTRACT

Computer-readable media, computer systems, and computing devices for inserting online content within editable content of a document being composed or manipulated within a document-authoring application, without exiting the document-authoring application or leaving a context of composing or manipulating the document, are provided. Initially, a user-initiated selection of a portion of the editable content within the document is detected. The selected portion of the editable content is automatically distributed to a search engine, where the search engine is equipped to generate search results that are relevant to the selected portion. Upon receiving the search results, they are presented to the user. At this point, the user is allowed to target at least one of the presented search results. Online content associated with the targeted search result is then inserted within the editable content of the document.

### BACKGROUND

Conventionally, when a user desires to include online content or other web-based information within a document being edited using a document-authoring application (e.g., Word, PowerPoint, Outlook, Wordpress, Mobile, OneNote, Excel) it is generally necessary for the user to perform a number of operations. For instance, these operations may include leaving the document, opening a web browser, conducting a search in a browser by entering a search query into a search box and navigating to a particular web page, visually identifying one or more of the search results or content of the web page as relevant, copying the content to a clipboard, and pasting the content from the clipboard into the document. Such a process is time consuming and inefficient, as the user is required to leave the document-authoring application to access the web browser.

The capability exists within document-editing applications to insert a static picture from a predefined listing of pictures by navigating through a series of folders and files. But the use of this insert operation does eliminate the use of the clipboard. Further, the current listing of pictures is severely limited in the variety of content that the user can insert into the document. Accordingly, a more efficient way in import content (e.g., image file, automatically updatable text, or movie player) from an online location into a document that is currently being edited would enhance a user's authoring experience.

### SUMMARY

This summary introduces simplified concepts of gesture-based searching, which is further described below in the Detailed Description. This summary is not intended to identify essential features of the claimed subject matter, nor is it intended for use in limiting the scope of the claimed subject matter.

This application describes example embodiments for incorporating online content within a document being composed and/or manipulating (e.g., editing, reorganizing, or reformatting) within a document-authoring application without exiting the document-authoring application or leaving a context of composing or manipulating the document. Initially, when a user wants to include online content or web-based information within an document, such as a Microsoft Word document, that is running within the document-authoring application, it was previously necessary for the user to leave the document, conduct a search in a browser application separate from the document-authoring application, copy some online content to a clipboard, and paste the copied online content into the document.

To resolve the inefficiencies created by the scenario above (e.g., bouncing between at least two distinct applications), embodiments of the present invention introduce adding the functionality of searching for online content to a document-authoring application (e.g., Word, PowerPoint, Outlook, Wordpress, Mobile, OneNote, Excel). In one instance, the online-searching functionality is invoked by the user selecting a search control (e.g., charm, icon, or control button) within the document-authoring application. In another instance, a gesture directed to content displayed within a touch screen allows the user to activate the online-searching functionality from within the document-authoring application. In yet another instance, the document-authoring application includes a mechanism running in the background that automatically retrieves and presents search results that are relevant to portions of the content within the document while the document is currently being composed and/or manipulated within the document-authoring application.

Once the online-searching functionality discovers the sought-after content from an online location (e.g., web page or website), the retrieved content is presented to the user. In one instance, the retrieved content is automatically integrated within the editable content of the document. In another instance, the user is prompted to select one or more pieces of the retrieved content for insertion into a targeted position within the document. When selecting the piece(s) of retrieved content being presented to the user, the user is allowed to perform an entity-selection action with respect to the retrieved content from within the confines of the document-authoring application. That is, the entity-selection action permits the user to choose the appropriate retrieved content for incorporation within the editable content of the document directly from the document-authoring application without the need to cut and paste.

In operation, the entity-selection action is enabled to pick one or multiple entities for incorporation into the document. In other embodiments, the entity-selection action allows the user to designate one or multiple fields associated with an entity for incorporation into the document. These entities (e.g., person, place, or thing) generally relate to content (e.g., images, passages of text, video, predefined instant answers) that may be drawn from any online location. Once selected, the desired content may be incorporated within the document in any fashion known in the software industry. For example, the selected content may be inserted within the editable content of the document as a live link that may be dynamically updated when the underlying online source is modified, thus, the document is rendered crawlable. The use of a live link allows for zooming into the inserted content, while within the document-authoring application, in order to explore additional information about an entity behind the inserted content. In embodiments, the inserted content is visually depicted differently from the rest of the editable content in the document to indicate to the user that the inserted content has additional functionality (e.g., updateable or zoomable) associated therewith. In view of the above, it can be seen that embodiments of the present invention provide the ability for a document-authoring application to be populated with online content without exiting the document-authoring application or leaving the context of writing/editing the document in progress.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates substantially similar or identical items.

FIG. 1 is a block diagram of an exemplary computing environment suitable for use in implementing embodiments of the present invention;

FIG. 2 is a graphical representation illustrating an exemplary system for incorporating online content within editable content of a document being composed and/or manipulated within a document-authoring application without leaving the document-authoring application, in accordance with embodiments of the present invention;

FIG. 3 is an illustrative screen display of exemplary interactions that may be taken by a user to submit content for an online search from within the document-authoring application, in accordance with embodiments of the present invention;

FIG. 4 is an illustrative screen display of additional exemplary interactions that may be taken by the user to submit content for an online search from within the document-authoring application, in accordance with embodiments of the present invention;

FIG. 5 is an illustrative screen display of an exemplary user interface for incorporating portions of online content within the document using fields, in accordance with embodiments of the present invention;

FIGS. 6 and 7 are illustrative screen displays of an exemplary user interface for incorporating portions of online content the context of a messaging application, in accordance with embodiments of the present invention;

FIG. 8 is a flow diagram showing an overall method for seamlessly inserting online content within a document in the process of being composed or manipulated, in accordance with an embodiment of the present invention; and

FIG. 9 is a flow diagram showing an overall method for retrieving a set of search results based on, in part, editable content of a document within the context of a document-authoring application, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention provide systems, media, and computerized methods for inserting online content within editable content of a document being composed and/or manipulated via a document-authoring application without leaving the document-authoring application. As used herein, the phrase “document-authoring application” is not meant to be limited and is intended to encompass all software that is designed or configured to edit, compose, reformat, reorganize, manipulate, and/or generally revise content within a document. Examples of a document-authoring application include Word, PowerPoint, Outlook, Wordpress, Mobile, OneNote, Excel, and the like. Although the figures below illustrate the document-authoring application as both Microsoft Word and Microsoft Outlook, embodiments of the present invention include any and all software that has editing functionality within the definition of document-authoring applications.

In operation, the document-authoring application provides the user the ability to access online-searching functionality from within the document-authoring application without exiting the document-authoring application or leaving the document that is the current subject of the user's attention. The document-authoring application of the present invention also provides the user the ability to populate the document with online content retrieved using the online-searching functionality. The ability to populate the document with online content may include pulling the online content into a Word document at a certain location in which the user has targeted. Specific examples of pulling the online content into the document may include pulling public information (e.g., a movie trailer or name of a restaurant) into an e-mail, and pulling private information (e.g., a travel itinerary) into a spreadsheet for generating an expense report. Accordingly, the steps of leaving the context of the document to conduct a web search with a separate browser application and cutting/pasting results from the web search are eliminated.

In embodiments of the present invention, a computer-implemented method for seamlessly inserting online content within a document in the process of being composed or manipulated is introduced. The method involves recognizing a user is composing or manipulating editable content of a document using a document-authoring application. When a user-initiated selection of a portion of the editable content within the document is detected, indicia of the selected portion of the editable content are automatically distributed to a search engine. The search engine is equipped to generate a set of search results that are relevant to the selected portion of the editable content. Further, this interaction with the search engine is performed without exiting the document-authoring application or leaving a context of composing or manipulating the document.

The document-authoring application may receive a set of search results that are relevant to the selected portion of the editable content. At this point, the user may be presented with representations of one or more of the set of search results, typically within a search window. Upon detecting a user-initiated indication targeting at least one of the set of search results, the method may comprise inserting online content associated with the targeted search result within the editable content of the document.

In embodiments, the online content may represent a static object or a dynamic object. The static object generally remains unchanged in appearance upon a web document underlying the targeted search result being updated. On the other hand, the dynamic object is linked to a web document underlying the targeted search result such that updates to the web document are reflected within the dynamic object.

In some embodiments, detecting the user-initiated selection of the portion of the editable content within the document involves recognizing an entity-selection action that is directed to a word or phrase within the editable content. As used herein, the phrase “entity-selection action” is meant to represent any action, command, or indication that may be interpreted as targeting, focusing on, or being directed to a portion of the document being composed or manipulated within the document-authoring application. By way of example only, the entity-selection action may comprise highlighting a word or phrase, actuation of a search control while a word or phrase is set off within the editable content, or inputting a word or phrase within a text-entry box pinned to a toolbar of the document-authoring application.

In another instance, embodiments of the present invention relate to computer-readable media storing instructions that, when executed by a processor, configure the processor to perform acts. These acts may include, in no particular order, detecting a user is adding a word or phrase to editable content of a document using a document-authoring application, and automatically comparing the added word or phrase against a preestablished index of entities. Upon performing the comparison, an entity is identified from the index of entities that corresponds with the added word or phrase.

As used herein, the term “entity” generally refers to logical objects that may be represented by a particular online description. These logical objects may be a person, place, thing, or any combination thereof. For instance, some examples of logical objects are the following: the movie Avatar; the restaurant Shiva's; the CEO of Microsoft; Alaska Airlines' flight #AS331; and the Canon PowerShot digital camera. Accordingly, technology introduced by embodiments of the present invention allows for automatically distilling a task being carried out by a user and for retrieving information based on the distilled task. Generally, this technology helps disambiguate a user's true searching intent during when selecting a portion of a document. In this way, upon comparing the selected portion of the document being composed or manipulated against one or more predefined entities of interest, those entities may be used to glean the user's overall, pending intent for a search in a way that is sufficiently transparent to the user.

Once an entity that is comparable to the selected portion of the document is identified, a process for gathering a set of search results that are relevant to the identified entity is initiated. In an exemplary embodiment, this process is carried out without exiting the document-authoring application or leaving a context of composing or manipulating the document. In embodiments, this process involves interacting with a search engine that compiles the set of search results using any known searching techniques. Representations of online content associated with one or more of the set of search results is presented to the user.

In embodiments, presenting the representations of the online content to the user involves launching a searching window within the document-authoring application, and allowing the user to select at least one of the representations of the online content associated with one or more of the set of search results. The document-authoring application may receive an indication that the user has selected at least one of the representations of the online content. In response to the indication, the document-authoring application may insert the indicated online content within the document-authoring application. In embodiments, inserting may include incorporating a portion of the online content in proximity to the added word or phrase within the editable content of the document. As used herein, the phrase “online content” is not meant to be limiting, but may encompass all types of content, such as summary of a web page, a digital image, a video file, a passage from a web page, a link to a web page, metadata, or an updatable canvas.

In still other embodiments of the present invention, a computing device is employed to carry out certain steps of process for inserting online content into a document being edited by a document-authoring application. The computing device includes a processing unit coupled to a computer storage medium. The computer storage medium hosts a plurality of computer software components executable by the processing unit. The computer software components include a controls component, an auto-suggest mechanism, a presentation component, and an insertion component. In one instance, the controls component supports one or more tools to receive an entity-selection action from a user targeted to a portion of editable content within a document being composed or manipulated using a document-authoring application. The auto-suggest mechanism is configured to distribute indicia of the targeted portion of the editable document for resolution by a search engine. Typically, the search engine is configured to generate a set of search results that are relevant to the targeted portion of the editable document.

The presentation component is configured for displaying to the user representations of one or more of the set of search results within a search window and allowing the user to perform a selection upon at least one of the representations. The insertion component that, upon receiving the user's selection within the search window, incorporates online content associated with the selected search result(s) within the editable content of the document.

The software components may further include a browser component that interacts with a search engine. Generally, the browser component is communicatively coupled to the document-authoring application over an operating system of the user device. In operation, the interaction between the browser component and the search engine is carried out without exiting the document-authoring application or leaving a context of composing or manipulating the document.

Multiple and varied implementations and embodiments are described below. The following section describes an example environment that is suitable for implementing embodiments of the present invention. The following sections describe illustrative aspects of the techniques for carrying out embodiments of the present invention. Having briefly described an overview of embodiments of the present invention, an exemplary operating environment suitable for implementing the present invention is described below.

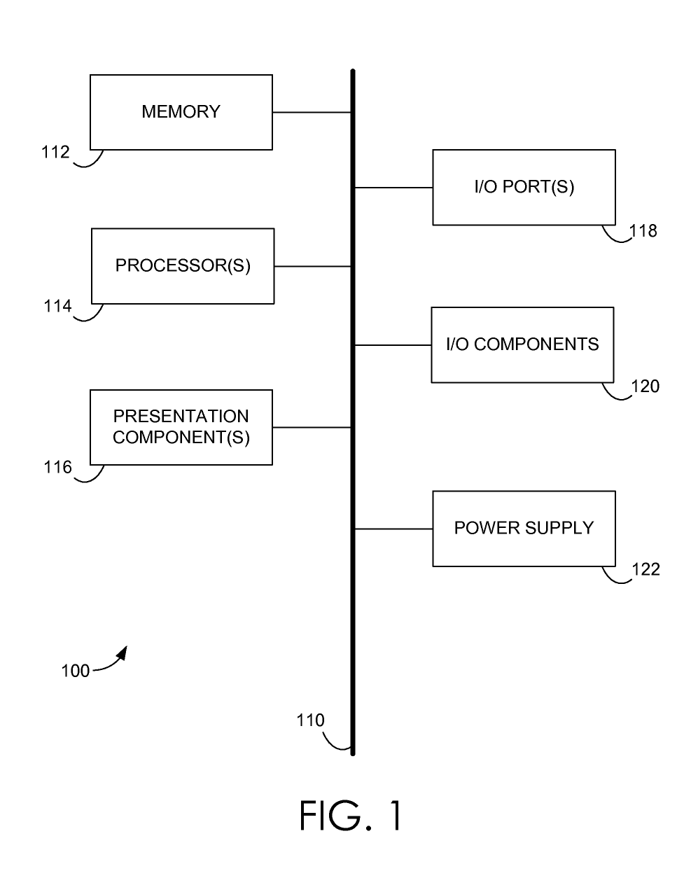

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. The invention may be practiced in a variety of system configurations, including handheld devices, consumer electronics, general-purpose computers, specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and refer to “computing device.”

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media.

Computer storage media includes volatile and nonvolatile, removable and nonremovable media implemented in any method or technology for storage of information such as computer-readable instructions, data structures, program modules, or other data. Computer storage media include, but are not limited to, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media typically embody computer-readable instructions, data structures, program modules, or other data in a modulated data signal, such as a carrier wave or other transport mechanism, and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media; however, as defined herein, computer storage media does not include communication media.

Memory 112 includes computer-storage media in the form of volatile and/or nonvolatile memory. The memory may be removable, nonremovable, or a combination thereof. Exemplary hardware devices include solid-state memory, hard drives, optical-disk drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

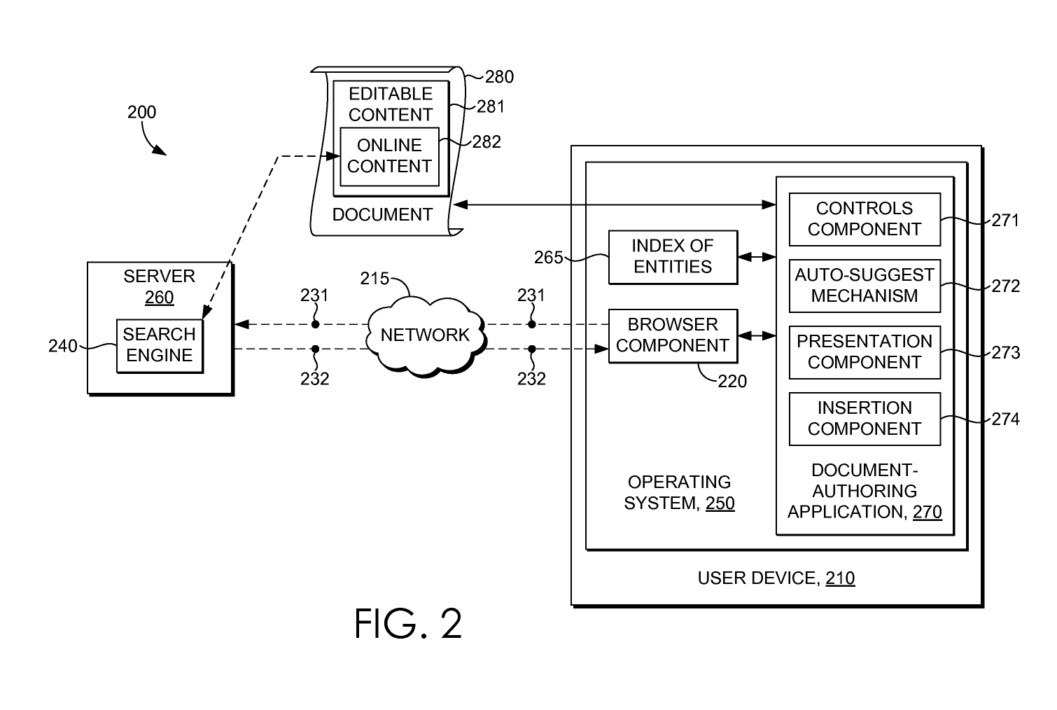

Turning now to FIG. 2, a graphical representation illustrating an exemplary system 200 for incorporating online content within editable content of a document being composed and/or manipulated within a document-authoring application without leaving the document-authoring application is shown, in accordance with embodiments of the present invention. It will be understood and appreciated by those of ordinary skill in the art that the computing system 200 shown in FIG. 2 is merely an example of one suitable portion of an environment for resolving a search query for a person and is not intended to suggest any limitation as to the scope of the use or functionality of the present invention. Neither should the architecture of the computing system 200 be interpreted as having any dependency or requirement related to any single resource or combination of resources illustrated herein.

The system architecture for implementing the method of inserting online content 282 within editable content 281 of a document 280, as well as other processes, will now be described with reference to FIG. 2. Initially, FIG. 2 is a block diagram illustrating an environment of a distributed computing system 200 suitable for use in implementing embodiments of the present invention. The exemplary computing environment includes a user device 210 that has an operating system 250 running thereon, a server 260, and a network 215 that interconnects each of these items. Each of the user device 210 and the server 260 shown in FIG. 2, may take the form of various types of computing devices, such as, for example, the computing device 100 described above with reference to FIG. 1. By way of example only and not limitation, the user device 210 and/or the server 260 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, the user device 210 includes, or is linked to, some form of computing unit (e.g., central processing unit, microprocessor) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the user device 210 to enable the device to perform communication-related processes and other operations. In another instance, the computing unit may encompass a processor (not shown) coupled to the computer-readable medium accommodated by the user device 210.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the user device 210. Generally, resources refer to the operating system 250, software components, or other mechanisms that enable the user device 210 or the web server 260 to perform a particular function. By way of example only, resource(s) accommodated by a server 260 operate to assist the search engine 240 in receiving inputs from a user at the user device 210 and/or providing an appropriate communication in response to the inputs.

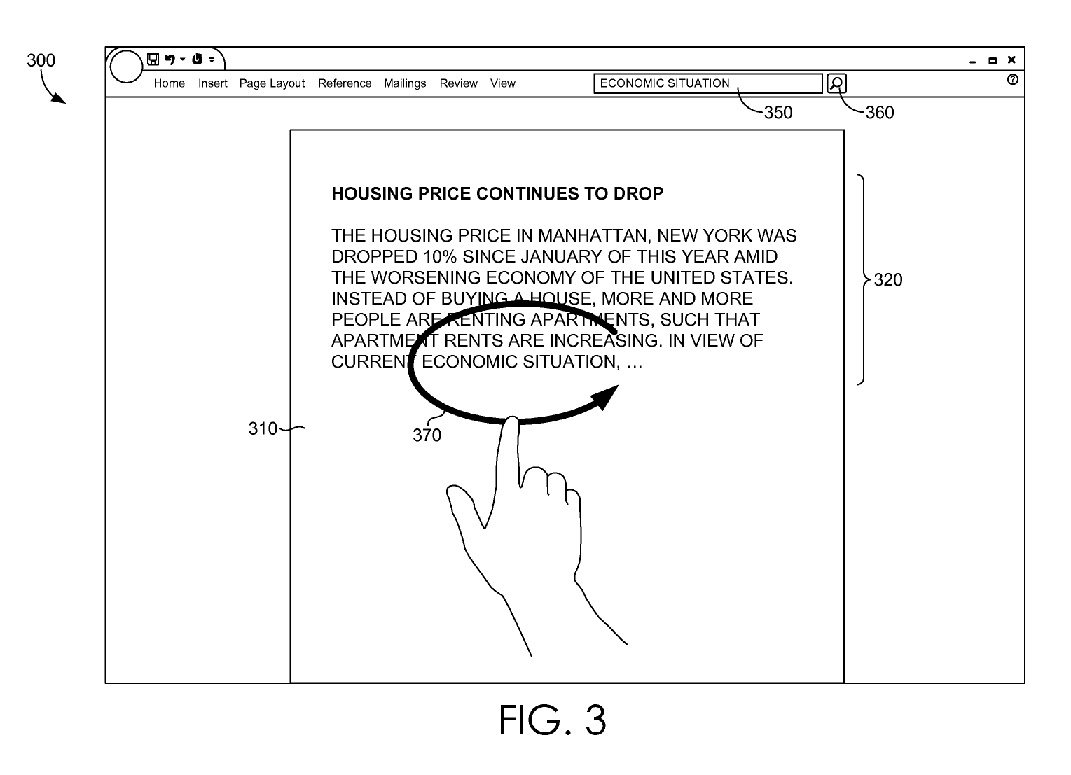

The user device 210 may include an input device (not shown) and a presentation device for presenting user interfaces (UIs) of FIGS. 3-7. Generally, the input device is provided to receive input(s) affecting, among other things, editable content 281 of the document 280 being composed or manipulated by the document-authoring application 270. Illustrative input devices include a mouse, joystick, key pad, microphone, I/O components 120 of FIG. 1, or any other component capable of receiving a user input and communicating an indication of that input to the user device 210. By way of example only, the input device facilitates entry of a portion of the document 280, which is communicated over the network 215 by a browser component 220, for processing by the search engine 240.

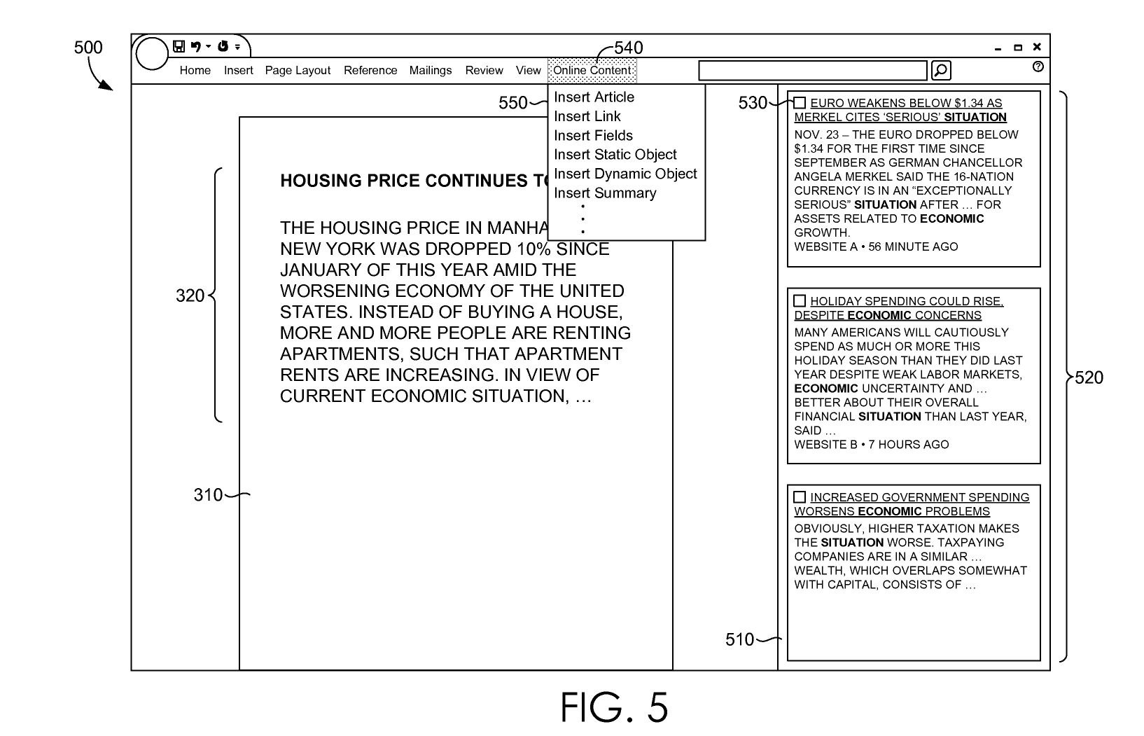

In embodiments, the presentation device of the user device is configured to render and/or present the editable content 281 of the documents and, at time, the online content 282 within a search window (e.g., search window 510 of FIG. 5). The search window is configured to include a list of the search results, online content, or other information relevant to the document 280 that are returned in response to some invocation from the document-authoring application 270, either automatically or manually triggered.

The presentation device, which is operably coupled to an output of the user device 210, may be configured as any presentation component that is capable of presenting information to a user, such as a digital monitor, electronic display panel, touch-screen, analog set-top box, plasma screen, audio speakers, Braille pad, and the like. In one exemplary embodiment, the presentation device is configured to present rich content, such as digital images and videos. In another exemplary embodiment, the presentation device is capable of rendering other forms of media (i.e., audio signals).

The devices 210 and 260 of the architecture of the exemplary system 200 may be interconnected by any method known in the relevant field. For instance, the user device 210 and the server 260 may be operably coupled via a distributed computing environment that includes multiple computing devices coupled with one another via one or more networks (e.g., network 215). In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

The operating system 250 represents a collection of software that manages computer-hardware resources and provides common services for computer programs, such as the document-authoring application 270, the browser component 220, and the index of entities 265. The document-authoring application 270 (e.g., Word, PowerPoint, Outlook, Wordpress, Mobile, OneNote, Excel) represents a computer program with the added functionality of searching for online content to a document-authoring application. In one instance, the online-searching functionality is invoked by the user selecting a search control (e.g., charm, icon, or control button) within the document-authoring application 270. In another instance, a gesture directed to content displayed within a touch-screen allows the user to activate the online-searching functionality from within the document-authoring application 270. In yet another instance, the document-authoring application 270 includes a mechanism (e.g., auto-suggest mechanism 272) running in the background that automatically retrieves and presents search results 232 that are relevant to portions of the editable content 281 within the document 280 while the document 280 is currently being composed and/or manipulated within the document-authoring application 270.

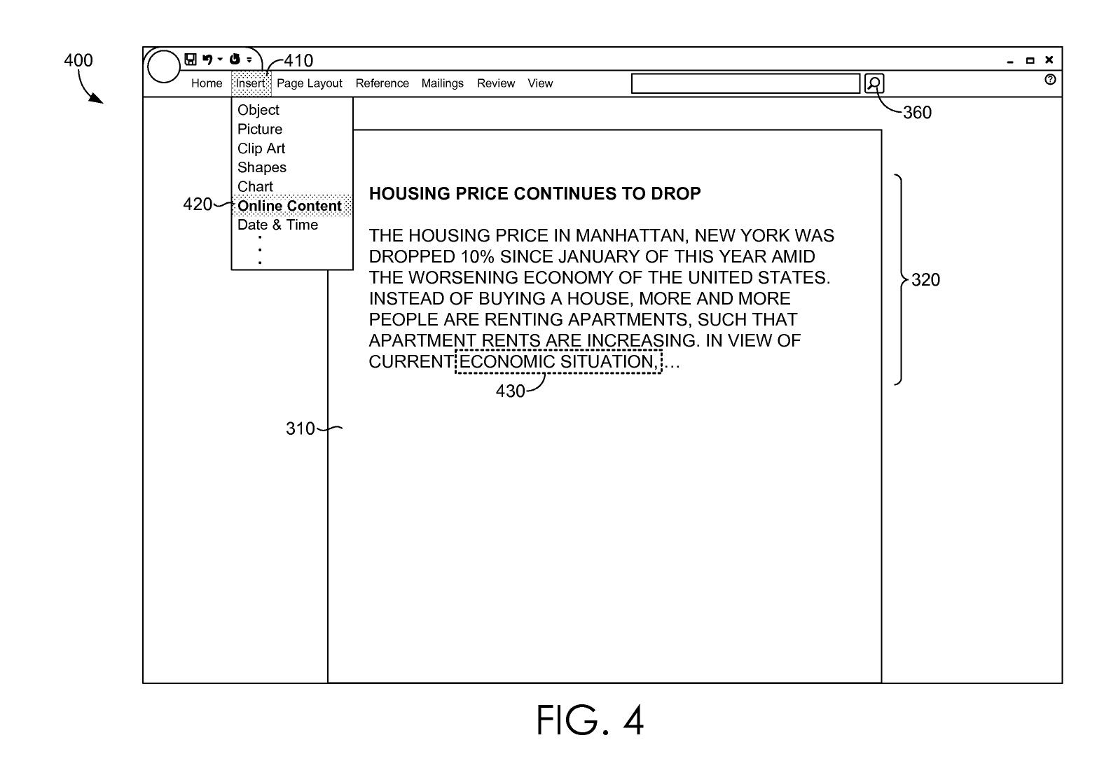

A discussion of the computer software components of the document-authoring application 270 will now commence. In embodiments, the components include a controls component 271, an auto-suggest mechanism 272, a presentation component 273, and an insertion component 274. In one instance, the controls component 271 supports one or more tools to receive an entity-selection action from a user targeted to a portion of editable content within a document 280 being composed or manipulated using a document-authoring application 270. Turning now to FIGS. 3 and 4, examples of entity-selection actions are illustrated. With reference to FIG. 3, a user interface 300 shows a document 310 being displayed with editable content 320. Two distinct exemplary entity-selection actions are demonstrated: a text-entry action and a gesture 370 for use on a touch screen.

The text-entry action involves entering a word or phrase into a search box 350 and, upon entry, selecting a search control 360. Selection of the search control 360 within the confines of the document-authoring application 270 invokes the browser component 220 to distribute the entered word or phrase as a search query 231 to the search engine 240 or other searching service (e.g., searching mechanism internal to the user device 210).

The search engine 240 is designed for searching for information on the Internet for gathering Internet search results in response to the search query 231 that may be explicitly or implicitly submitted through the document-authoring application 270. In one embodiment, the search engine 240 includes one or more web crawlers that mine available data (e.g., newsgroups, databases, or open directories) accessible via the Internet and build a table containing web addresses along with the subject matter (e.g., online content 282) of web pages identified as the search results 232 that are relevant to search terms within the search query 231. The search engine 240 may be accessed by Internet users through the browser component 220. Accordingly, the users may conduct an Internet search by submitting search terms at a text-entry box 350, or other query-entry area on a UI display, presented within the confines of the document-authoring application 270.

With continued reference to FIG. 3, the gesture 370 will now be discussed. The gesture 370, which is often conducted on a touch-screen display of the user device 210, is used to manually select a portion of editable content 320, or any other content, within the document 310. The editable content 320 is displayed on a display, such as the presentation device of the user device 210. The editable content 320 may include text, an image, a picture, a visual representation of audio content, and/or video. The editable content 320 may be displayed within the document-authoring application 270, as opposed to a web browser.

The gesture 370 defines a region of content that is detected using the controls component 271 of FIG. 2. The gesture 370 may include a touch input on a touch screen or touch pad, a body motion detected by an image capture device, and/or a motion of a cursor controlled by a user input device. The region of content, or selected portion of editable content 320, defined by the gesture 370 may include a region that is bounded or substantially bounded by the search gesture, a region that is touched by, proximate to, or overlapped by the search gesture. In one example, the gesture 370 may include a substantially circular motion that bounds or substantially bounds the region of content.

In response to detecting the gesture 370, a representation of the region of content defined by the gesture 370 may be displayed to the user. The representation of the region of content may include a line enclosing the region of content, a highlighting view of the region of content, and/or a magnifying lens view of the region of content. In another instance, the representation of the region of content may be presented to the user within the text-entry box 350, thereby allowing the user to edit the content prior to submission to the search engine 240.

The search query 231 may be formulated based upon the region of content defined by the gesture 370. For instance, the search query 231 may be based on the content within the region and, possibly, context information, which is relevant to the selected portion of the editable content 320. The context information may include content proximate to the region of content, a paragraph having a portion thereof within the region of content, a sentence having a portion thereof within the region of content, a title of a document having a portion of the document within the region of content, a uniform resource locator where the displayed content is located, an application identifier of an application used to display the displayed content, metadata associated with the displayed content, and/or a geographic location of the client device performing the search.

A search using the search query 231 may be automatically caused to be performed in response to completion of the gesture 370. The search query 231 may be sent to a remote search engine 240, which is separate from the user device 210. Additionally or alternatively, the search may be performed locally in the user device 210. Search results 232 are displayed on a UI display within the presentation device of the user device 210, as discussed more fully below.

In another embodiment, with reference to a UI 400 of FIG. 4, the user may highlight text 430 within the editable content 320 of the document 310 and select a search control 360 (e.g., control button pinned to the toolbar of the document-authoring application 270) that triggers conducting a search on the highlighted text 430. By way of example only, a user may invoke the search by highlighting a passage (e.g., “economic situation”) within the document 310. Highlighting the passage may involve one or multiple operations, such as swiping or tapping a term or phrase within the editable content 320. Upon selecting the appropriate region of content, the highlighted text 430 is submitted to the search engine 240. Submission to the search engine may involve one or more actions. In one instance, the actions involve selecting the search control 360. In another instance, the actions involve selecting a tab 410 (e.g., “insert” tab pinned to the toolbar of the document-authoring application 270) that produces a drop-down menu, and selecting an appropriate item 420 (e.g., “online content”) from the drop-down menu. Selection of the item 420 from the drop-down menu will issue the highlighted text 430 as a search query 231 directly from the document 310 without leaving the document-authoring application 270 or cutting and pasting content from the document 310 for subsequent entry within another application (e.g., web-browsing application).

In other embodiments, with reference to FIG. 2, the auto-suggest mechanism 272 is configured to distribute indicia of a targeted portion of the editable content 281 for resolution by a search engine 240. Typically, the auto-suggest mechanism 272 represents a content-aware monitoring mechanism that is equipped to dynamically scan the content of the document 280 and automatically submits pertinent information to the search engine 240, as opposed to detecting manually targeted content via the controls component 271.

As mentioned above, the search engine 240 is configured to generate a set of search results 232 that are relevant to the targeted portion of the editable document 281. Accordingly, at the request of the auto-suggest mechanism 272, the search engine 240 returns examples of relevant online content via a searching window as the document is in the process of being composed or manipulated by the document-authoring application 270. As used herein, the automatically “targeted portion” of the editable content 281 of the document 280 may refer to any content of the document 280, including recently added terms or phrases, key text, or text that corresponds with entities within the index of entities 265. Accordingly, the auto-suggest mechanism 272 represents a tool that indicates to the user it understands the content of the document 280 and knows something further about the content. Thus, the auto-suggest mechanism 272 may be configured to extract not just the targeted portion of the content, but all interesting information surrounding the targeted portion and compile the search query 231 from that aggregation of information.

The presentation component 273 is configured for displaying to the user representations of one or more of the set of search results within a search window and allowing the user to perform a selection upon at least one of the representations. The searching window represents an interface that allows the user to view online content upon the user selecting a search control within the document-authoring application 270, as discussed above. In one embodiment, with reference to FIG. 5, selection of the search control allows the user to launch the searching window 510 and commence a search at the searching window 510 from within the document-authoring application 270. In one aspect, the searching window 510 may be configured with navigation controls that allow for easier selection of online content 520. The navigation controls on the searching window 510 allow the user to find, select, and integrate the desired online content into the document 310 currently being edited.

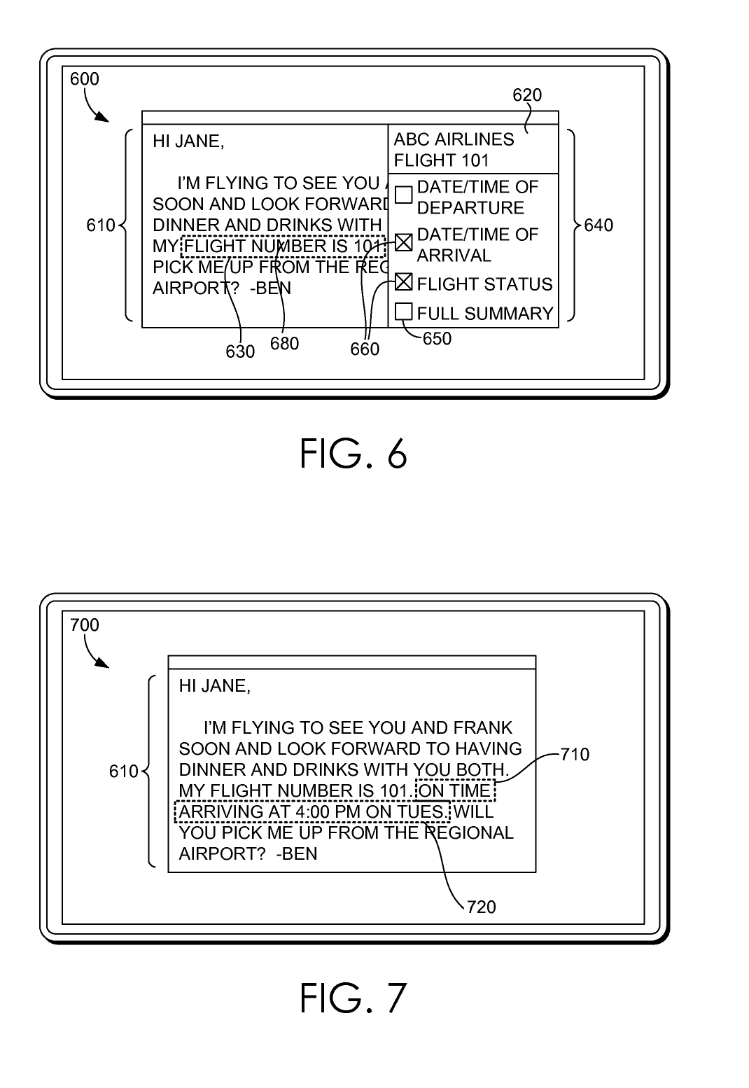

Accordingly, the searching window 510 allows the user to move into and out of a search environment seamlessly. For instance, with respect to FIGS. 6 and 7, information may be pulled into a messaging-based application (e.g., SMS or e-mail) presently being employed without leaving the messaging-based application or having to open another window or separate application. Thus, the search window 510 eliminates the need for switching between applications and for cutting and pasting content.

Upon receiving the user's selection within the search window 510 of FIG. 5, the insertion component 274 of FIG. 2 is configured to incorporate the online content 520 associated with the selected search result(s) within the editable content 320 of the document 310, where the online content 520 may be inserted into the document 310 in place of or after the targeted portion of editable content 320. In embodiments, an action of selection from the search window 510 may involve any number of actions directed to the online content 520. In one instance, the selection action may pick the online content of one search result for incorporation into the document (e.g., by checking a selection box 530 associated with the search result). In another instance, the selection action may pick multiple search results for incorporation of their online content into the document 310 (e.g., including many recipes into a menu or cookbook application).

The type of online content that may be injected into the document using the selection action may vary broadly. For example, the online content may include the text within the selected search result(s) themselves or metadata describing the selected search result(s). In another instance, the selection action can designate a predefined set of fields 550 associated with a search result for incorporation into the document 310 (e.g., incorporate all relevant information about a book into an e-mail). In embodiments, a selection action may involve a single field selection (e.g., including one piece of information about a movie in an e-mail) or a multiple field selection (e.g., including all information about the movie). The fields may comprise system-determined fields (e.g., predefined information about a movie that is most relevant or frequently accessed, such as title, director, and actors) and/or user-generated fields (e.g., information that the user believes to be most important, such as a picture linked to the trailer, summary, and locations/show times). Further, the type of online content offered for insertion into the document 310 may be public (e.g., restaurant information) or private (e.g., bank account information).

Accordingly, the selection action allows a user to manually select from various fields 550 associated with online content 520 for incorporation into the document 310. As shown in FIG. 5, the fields 550 may be surfaced upon selecting an item (e.g., “online content”) pinned to the toolbar of the document-authoring application 270, or elsewhere, and may be related to attributes, including rich content, of the search results(s) that the user desires to inject into the document 310.

With reference to FIGS. 6 and 7, the desired online content may be incorporated within the document 610 as a static object, a dynamic object, or both. In FIG. 6, a UI 600 is shown with a messaging-based application in which text is being entered into a document 610 (e.g., e-mail, text, MMS, or SMS, message). Upon the user highlighting a portion 630 of the document 610 (e.g., text of “flight number is 101” 680), the document-authoring application 270 will automatically retrieve one or more search results 620 relevant to the highlighted portion 630. Further, within a search window 640, fields of the search result 620 will be shown with controls 650 that allow a user to specifically define the type of online content that is to be added to the document 610. As show, the user has selected two of the fields 660 for inclusion into the document 310.

In FIG. 7, a UI 700 is shown with the online content from the selected fields 660 of the search window of FIG. 6, within the document 610 of the messaging-based application. The online content associated with the “date/time of arrival” field is inserted as a static object 720, as that type of information is unlikely to change over time. As mentioned above, a static object includes a representation of online content that is disconnected to a source document (e.g., web page). Thus, the static object 720, upon insertion to the document 610, will not change even when underlying content within the source document is updated.

The online content associated with the “flight status” field is inserted as a dynamic object 710, as that type of information is likely to change over time. As mentioned above, a dynamic object (e.g., stock quote ticker) includes a representation of online content that is connected to the source document. Thus, the dynamic object 710, upon insertion to the document 610, will change even to reflect underlying content within the source document when updated. In one embodiment, the dynamic object 710 represents a live link with a dynamic canvas that may be dynamically linked with underlying content in real time, thus, the document 610 is rendered crawlable. In one instance, a crawlable document employs the search engine 240 to look up the current information linked to the inserted online content and make any necessary updates (e.g., allowing an inserted map to update in real time). Further, the crawlable document may show or hide and embed a source of the online content, thereby allowing for zooming into the inserted online content, while within the document-authoring application, in order to explore additional information about the inserted online content. It should be noted that the inserted online content may be visually depicted as if it were cut and pasted (i.e., different from the editable content of the document), or may be visually depicted differently from the rest of the editable content within the document.

Returning to FIG. 2, the software components may further include the browser component 220 that interacts with a search engine 240. Generally, the browser component 220 is communicatively coupled to the document-authoring application 270 over the operating system 250 of the user device 210. In another embodiment, the browser component 220 may be integrated within the document-authoring component 270. In operation, the interaction between the browser component 220 and the search engine 240 is carried out without exiting the document-authoring application 270 or leaving a context of composing or manipulating the document 280. In yet another embodiment, the browser component 220 represents searching capability built into the operating system 250 that watches all interactions with the document-authoring application 270 and sends search queries to the search engine at appropriate times.

This distributed computing environment of FIG. 2 is but one example of a suitable environment that may be implemented to carry out aspects of the present invention and is not intended to suggest any limitation as to the scope of use or functionality of the invention. Nor should the illustrated distributed computing environment 200 be interpreted as having any dependency or requirement relating to any one or combination of the devices 210 or 260, or the components 220, 240, 265, and 271-274 as illustrated. In other embodiments, one or more of the components 220, 240, 265, and 271-274 may be integrated directly into the user device 210, the document-authoring application 270, the document 280 itself, or on distributed nodes that interconnect to form the server 260.

Accordingly, any number of components may be employed to achieve the desired functionality within the scope of embodiments of the present invention. Although the various components 220, 240, 265, and 271-274 of FIG. 2 are shown with lines for the sake of clarity, in reality, delineating various components is not so clear, and, metaphorically, the lines would more accurately be grey or fuzzy. Further, although some components of FIG. 2 are depicted as single blocks, the depictions are exemplary in nature and in number and are not to be construed as limiting (e.g., although only one search engine 240 is shown, many more may be communicatively coupled to the user device 210).

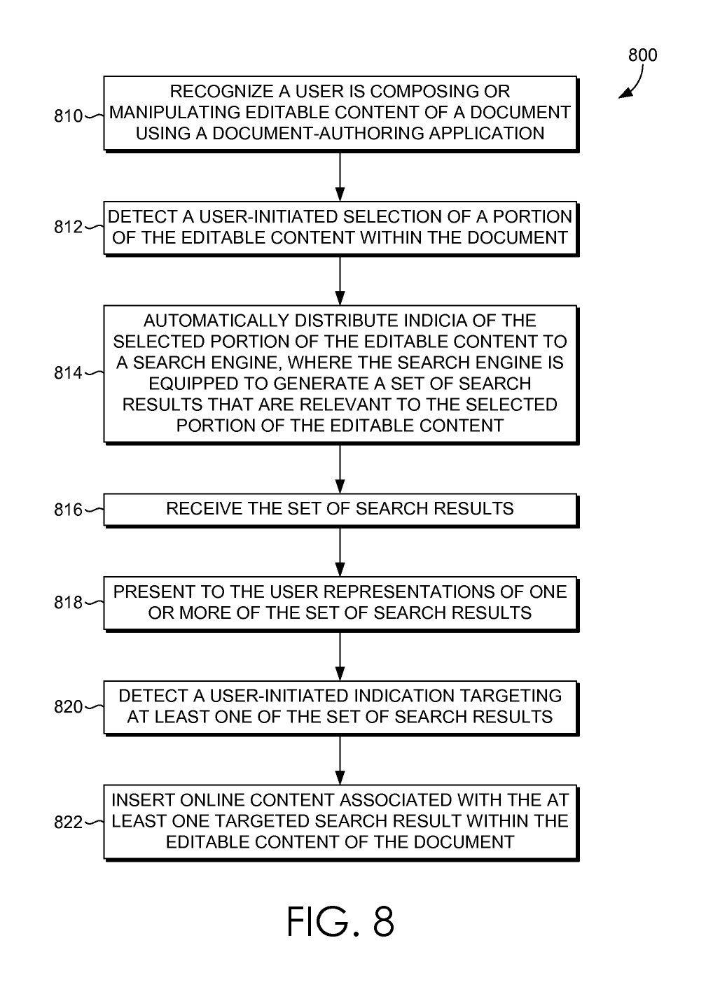

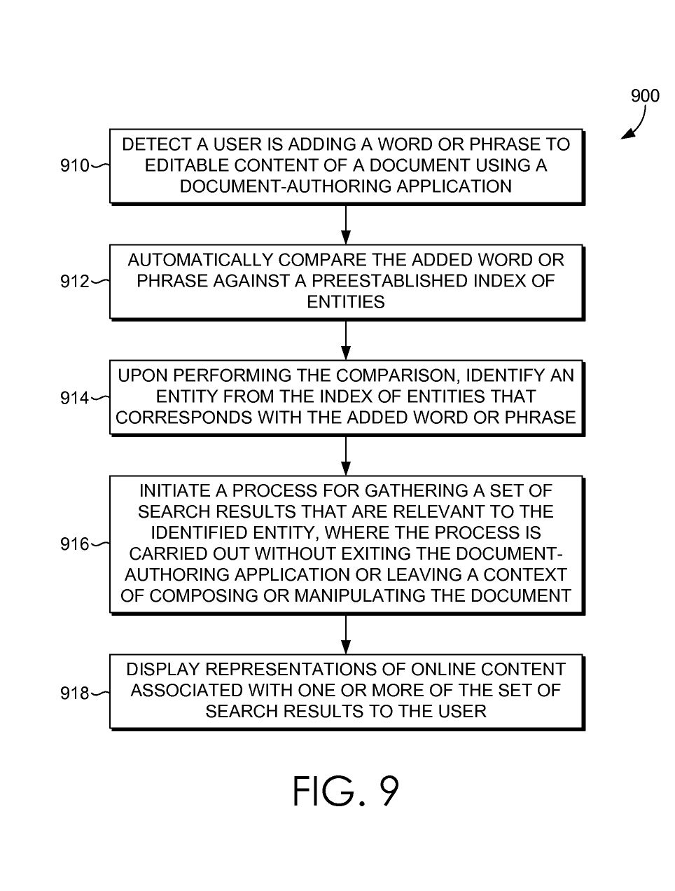

Exemplary methods for performing a gesture-based search are described with reference to FIGS. 8 and 9. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Turning to FIG. 8, a flow diagram showing an overall method 800 for seamlessly inserting online content within a document in the process of being composed or manipulated is shown, in accordance with an embodiment of the present invention. The method 800 may involve recognizing a user is composing or manipulating editable content of a document using a document-authoring application, as depicted at block 810. When a user-initiated selection of a portion of the editable content within the document is detected, as depicted at block 812, indicia of the selected portion of the editable content is automatically distributed to a search engine, as depicted at block 814. As depicted at block 816, the search engine is equipped to generate a set of search results that are relevant to the selected portion of the editable content. Further, this interaction with the search engine is performed without exiting the document-authoring application or leaving a context of composing or manipulating the document.

The document-authoring application may receive a set of search results that are relevant to the selected portion of the editable content, as depicted at block 816. At this point, the user may be presented with representations of one or more of the set of search results, typically within a search window, as depicted at block 818. Upon detecting a user-initiated indication targeting at least one of the set of search results, as depicted at block 820, the method 800 may comprise inserting online content associated with the targeted search result within the editable content of the document, as depicted at block 822.

Turning to FIG. 9, a flow diagram showing an overall method 900 for retrieving a set of search results based on, in part, editable content of a document within the context of a document-authoring application is shown, in accordance with an embodiment of the present invention. Initially, the method 900 involves detecting a user is adding a word or phrase to editable content of a document using a document-authoring application (see block 910) and automatically comparing the added word or phrase against a preestablished index of entities (see block 912). Upon performing the comparison (see block 912), an entity is identified from the index of entities (see reference numeral 265 of FIG. 2) that corresponds with the added word or phrase (see block 914). Once an entity that is comparable to the selected portion of the document is identified, a process for gathering a set of search results that are relevant to the identified entity is initiated, as depicted at block 916. In an exemplary embodiment, this process is carried out without exiting the document-authoring application or leaving a context of composing or manipulating the document. In embodiments, this process involves interacting with a search engine that compiles the set of search results using any known searching techniques. Representations of online content associated with one or more of the set of search results is presented to the user, as depicted at block 918.

Any of the acts of any of the methods described herein may be implemented at least partially by a processor or other electronic device based on instructions stored on one or more computer-readable media.

Although the invention has been described in language specific to structural features and/or methodological acts, it is to be understood that the invention is not necessarily limited to the specific features or acts described. Rather, the specific features and acts are disclosed as exemplary forms of implementing the invention.

The invention claimed is:

1. A computer-implemented method for seamlessly inserting online content within a document in the process of being composed or manipulated, the method comprising:
recognizing a user is composing or manipulating editable content of a document using a document-authoring application;
detecting a user-initiated selection of a portion of the editable content within the document;
automatically distributing indicia of the selected portion of the editable content to a search engine, wherein the search engine is equipped to generate a set of search results that are relevant to the selected portion of the editable content;
receiving the set of search results;
presenting to the user representations of one or more of the set of search results;
detecting a user-initiated indication targeting at least one of the set of search results; and
inserting online content associated with the at least one targeted search result within the editable content of the document.

2. The method of claim 1, wherein the online content represents a static object that is incorporated within the editable content of the document upon detecting the user-initiated indication directed to the at least one targeted search result.

3. The method of claim 2, wherein the static object remains unchanged in appearance upon a web document underlying the at least one targeted search result being updated.

4. The method of claim 1, wherein the online content represents a dynamic object that is incorporated within the editable content of the document upon detecting the user-initiated indication directed to the at least one targeted search result.

5. The method of claim 4, wherein the dynamic object is linked to a web document underlying the at least one targeted search result, wherein updates to the web document are reflected within the dynamic object.

6. The method of claim 1, wherein the method is performed without exiting the document-authoring application or leaving a context of composing or manipulating the document.

7. The method of claim 1, detecting a user-initiated selection of a portion of the editable content within the document comprises detecting an entity-selection action directed to a word or phrase within the editable content.

8. The method of claim 7, wherein the entity-selection action comprises highlighting the word or phrase.

9. The method of claim 7, wherein the entity-selection action comprises actuation of a search control while the added word or phrase is set off within the editable content.

10. The method of claim 7, wherein the entity-selection action comprises inputting the word or phrase within a text-entry box pinned to a toolbar of the document-authoring application.

11. One or more computer-readable media storing instructions that, when executed by a processor, configure the processor to perform acts comprising:
detecting a user is adding a word or phrase to editable content of a document using a document-authoring application;
automatically comparing the added word or phrase against a preestablished index of entities;
upon performing the comparison, identifying an entity from the index of entities that corresponds with the added word or phrase;
initiating a process for gathering a set of search results that are relevant to the identified entity, wherein the process is carried out without exiting the document-authoring application or leaving a context of composing or manipulating the document;
displaying representations of online content associated with one or more of the set of search results to the user.

12. The media of claim 11, wherein the method further comprises incorporating a portion of the online content in proximity to the added word or phrase within the editable content of the document.

13. The media of claim 11, wherein displaying representations comprises:
launching a searching window within the document-authoring application; and
allowing the user to select at least one of the representations of the online content associated with one or more of the set of search results.

14. The media of claim 13, wherein the method further comprises:
receiving an indication that the user has selected at least one of the representations of the online content; and
inserting the indicated online content within the document-authoring application.

15. The media of claim 11, wherein the online content represents at least one of a summary of a web page, a digital image, a video file, a passage from a web page, a link to a web page, metadata, or an updatable canvas.

16. The media of claim 11, wherein the representations of online content associated with one or more of the set of search results are displayed in a search window that overlaps a portion of the editable content within the document.

17. The media of claim 11, wherein the method further comprises reorganizing the editable content within the document such that no portion of the editable content is covered by a search window that displays representations of online content associated with one or more of the set of search results.

18. A user device comprising a processing unit coupled to a computer storage medium, the computer storage medium having stored thereon a plurality of computer software components executable by the processing unit, the computer software components comprising:
a controls component that supports one or more tools to receive an entity-selection action from a user targeted to a portion of editable content within a document being composed or manipulated using a document-authoring application;
an auto-suggest mechanism that distributes indicia of the targeted portion of the editable document for resolution by a search engine, wherein the search engine is configured to generate a set of search results that are relevant to the targeted portion of the editable document;
a presentation component that presents to the user representations of one or more of the set of search results within a search window and allowing the user to perform a selection upon at least one of the representations; and
an insertion component that, upon receiving the user's selection within the search window, incorporates online content associated with the at least one selected search result within the editable content of the document.

19. The user device of claim 18, wherein the computer software components further comprise a browser component that interacts with the search engine, wherein the browser component is communicatively coupled to the document-authoring application over an operating system of the user device.

20. The user device of claim 19, wherein the interaction between the browser component and the search engine is carried out without exiting the document-authoring application or leaving a context of composing or manipulating the document.
